(19) United States
(12) Patent Application Publication
(10) Pub. No.: US 2026/0262073 A1
(43) Pub. Date: Sep. 3, 2026

(54) CONTROLS, CONTROL METHODS AND PROGRAMS

(71) Applicant: NIPPON TELEGRAPH AND TELEPHONE CORPORATION, Tokyo (JP)

(72) Inventors: Yushi KOYASAKO, Musashino-shi, Tokyo (JP); Takashi YAMADA, Musashino-shi, Tokyo (JP)

(73) Assignee: NIPPON TELEGRAPH AND TELEPHONE CORPORATION, Tokyo (JP)

(21) Appl. No.: 18/718,383

(22) PCT Filed: Dec. 20, 2021
(86) PCT No.: PCT/JP2021/046982

§ 371 Date: Jun. 10, 2024

(51) Int. Cl. H04W 72/20; H04W 72/0446; H04W 72/566

(52) U.S. Cl. CPC H04W 72/20; H04W 72/0446; H04W 72/566

(57) ABSTRACT

One aspect of the present invention is a control device including: a reception unit configured to receive transmission information transmitted from a plurality of controlled devices; a control information derivation unit configured to derive control information for controlling the controlled device that has transmitted the transmission information according to the transmission information received by the reception unit; a transmission interval acquisition unit configured to acquire a transmission interval determined for each piece of control information as an interval for transmitting the control information derived by the control information derivation unit; a priority calculation unit configured to calculate a priority indicating that the control information with a shorter transmission interval acquired by the transmission interval acquisition unit is to be transmitted preferentially, as a priority for transmitting the control information; and a transmission unit configured to transmit the control information according to the priority calculated by the priority calculation unit.

### TECHNICAL FIELD

The present invention relates to technologies of a control device, a control method, and a program.

### BACKGROUND ART

Industrial Ethernet protocols such as PROFINET, Ethernet/IP and EtherCAT are used as networks for establishing communication between controlled devices and control devices for controlling the former. PROFINET has three classes: NRT, RT, and IRT. Of these, RT ensures real-time performance within 10 ms by uniformly setting 6 to a “priority” in the Ethernet frame shown in FIG. 15.

### CITATION LIST

### Non Patent Literature

[NPL 1] PROFINET System Overview (Japanese), June 2011
[NPL 2] PROFINET Design Guidelines (Japanese), December 2014
[NPL 3] Which settings do you have to comply with in a PROFINET RT network in conjunction with VLAN switches? [https: //support. industry. siemens. com/cs/document/24947500/whi ch-settings-do-you-have-to-comply-with-in-a-profinet-rt-network-in-conjunction-with-vlan-switches-?dti=0&dl=en&lc=es-PA]

### SUMMARY OF INVENTION

### Technical Problem

FIG. 16 is a diagram illustrating an example of delays in control information D1, D2, and D3 transmitted from the control device. The left side shows a transmission timing in the control device, and the right side shows a reception timing in the controlled device. The control information DI requires a transmission interval of 1 ms and is transmitted with the minimum transfer clock. The control information D3 has a transmission interval of 4 ms. Typically, although a real-time network is operated with the limited number of devices connected to the network so as not to lead to the situation illustrated in FIG. 16, in a case where the control device is operated by software or a communication distance between the controlled device and the control device is relatively long, there is possibility that real-time performance requirements of RT will not be able to be satisfied even if the “priority” is uniformly set to 6.

As described above, real-time performance may not be ensured even if the priority is set to 6 in prior art.

Considering the above circumstances, the present invention aims to provide a technology that can ensure real-time performance more reliably.

### Solution to Problem

One aspect of the present invention is a control device including: a reception unit configured to receive transmission information transmitted from a plurality of controlled devices; a control information derivation unit configured to derive control information for controlling the controlled device that has transmitted the transmission information according to the transmission information received by the reception unit; a transmission interval acquisition unit configured to acquire a transmission interval determined for each piece of control information as an interval for transmitting the control information derived by the control information derivation unit; a priority calculation unit configured to calculate a priority indicating that the control information with a shorter transmission interval acquired by the transmission interval acquisition unit is to be transmitted preferentially, as a priority for transmitting the control information; and a transmission unit configured to transmit the control information according to the priority calculated by the priority calculation unit.

Another aspect of the present invention is a control device including: a reception unit configured to receive transmission information transmitted from a plurality of controlled devices; a control information derivation unit configured to derive control information for controlling the controlled device that has transmitted the transmission information according to the transmission information received by the reception unit; a transmission interval acquisition unit configured to acquire a transmission interval determined for each piece of control information as an interval for transmitting the control information derived by the control information derivation unit; a bandwidth acquisition unit configured to acquire a bandwidth of a network for transmitting the control information; and a transmission unit configured to transmit the control information, wherein, when it is incapable of transmitting one piece of the control information to be transmitted in a certain time slot, because a bandwidth for transmitting one piece of the control information exceeds the bandwidth acquired by the bandwidth acquisition unit, the transmission unit is configured to transmit one piece of the control information by transmitting the control information with a transmission interval longer than a transmission interval for one piece of the control information in any of subsequent time slots.

Another aspect of the present invention is a control method including: a reception step of receiving transmission information transmitted from a plurality of controlled devices; a control information derivation step of deriving control information for controlling the controlled device that has transmitted the transmission information according to the transmission information received in the reception step; a transmission interval acquisition step of acquiring a transmission interval determined for each piece of control information as an interval for transmitting the control information derived in the control information derivation step; a priority calculation step of calculating a priority indicating that the control information with a shorter transmission interval acquired in the transmission interval acquisition step is to be transmitted preferentially, as a priority for transmitting the control information; and a transmission step of transmitting the control information according to the priority calculated in the priority calculation step.

Another aspect of the present invention is a control method including: a reception step of receiving transmission information transmitted from a plurality of controlled devices; a control information derivation step of deriving control information for controlling the controlled device that has transmitted the transmission information according to the transmission information received in the reception step; a transmission interval acquisition step of acquiring a transmission interval determined for each piece of control information as an interval for transmitting the control information derived in the control information derivation step; a bandwidth acquisition step of acquiring a bandwidth of a network for transmitting the control information; and a transmission step of transmitting the control information, wherein, when it is incapable of transmitting one piece of the control information to be transmitted in a certain time slot, because a bandwidth for transmitting one piece of the control information exceeds the bandwidth acquired in the bandwidth acquisition step, the transmission step includes transmitting one piece of the control information by transmitting the control information with a transmission interval longer than a transmission interval for one piece of the control information in any of subsequent time slots.

Another aspect of the present invention is a program for causing a computer to function as a control device, which allows the computer to operate as: a reception unit configured to receive transmission information transmitted from a plurality of controlled devices; a control information derivation unit configured to derive control information for controlling the controlled device that has transmitted the transmission information according to the transmission information received by the reception unit; a transmission interval acquisition unit configured to acquire a transmission interval determined for each piece of control information as an interval for transmitting the control information derived by the control information derivation unit; a priority calculation unit configured to calculate a priority indicating that the control information with a shorter transmission interval acquired by the transmission interval acquisition unit is to be transmitted preferentially, as a priority for transmitting the control information; and a transmission unit configured to transmit the control information according to the priority calculated by the priority calculation unit.

Another aspect of the present invention is a program for causing a computer to function as a control device, which allows the computer to operate as: a reception unit configured to receive transmission information transmitted from a plurality of controlled devices; a control information derivation unit configured to derive control information for controlling the controlled device that has transmitted the transmission information according to the transmission information received by the reception unit; a transmission interval acquisition unit configured to acquire a transmission interval determined for each piece of control information as an interval for transmitting the control information derived by the control information derivation unit; a bandwidth acquisition unit configured to acquire a bandwidth of a network for transmitting the control information; and a transmission unit configured to transmit the control information, wherein, when it is incapable of transmitting one piece of the control information to be transmitted in a certain time slot, because a bandwidth for transmitting one piece of the control information exceeds the bandwidth acquired by the bandwidth acquisition unit, the transmission unit is configured to transmit one piece of the control information by transmitting the control information with a transmission interval longer than a transmission interval for one piece of the control information in any of subsequent time slots.

### Advantageous Effects of Invention

The present invention can guarantee real-time performance in a more reliable manner.

### BRIEF DESCRIPTION OF DRAWINGS

FIG. 1 is a diagram illustrating a configuration example of a communication system including a control device.

FIG. 2 is a diagram illustrating another connection example of the communication system.

FIG. 3 is a diagram illustrating another connection example of the communication system.

FIG. 4 is a diagram illustrating another connection example of the communication system.

FIG. 5 is a diagram illustrating a configuration example of a control device according to a first embodiment.

FIG. 6A shows a transmission interval database indicating transmission intervals of control information.

FIG. 6B shows a priority database indicating priorities of control information.

FIG. 7 is a diagram illustrating a transmission timing and a reception timing.

FIG. 8 is a flowchart illustrating a flow of processing when transmission information is received by the control device according to the first embodiment.

FIG. 9 is a flowchart illustrating showing a flow of processing each time a transfer cycle starts in the first embodiment.

FIG. 10 is a diagram illustrating a configuration example of a control device according to a second embodiment.

FIG. 11A shows a transmission interval size database indicating transmission intervals of control information.

FIG. 11B shows a priority database indicating priorities of control information.

FIG. 12 is a diagram illustrating an example of changing the order of transmission.

FIG. 13 is a flowchart illustrating a flow of processing when the control device receives transmission information in the second embodiment.

FIG. 14 is a flowchart illustrating a flow of processing when transmitting control information in the second embodiment.

FIG. 15 is a diagram illustrating an Ethernet frame.

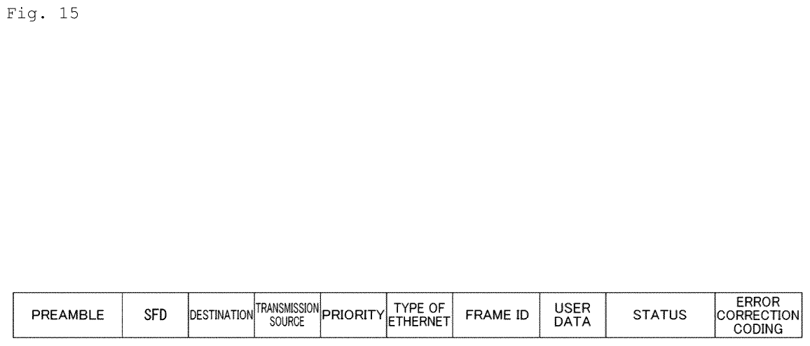

FIG. 16 is a diagram illustrating an example of delay.

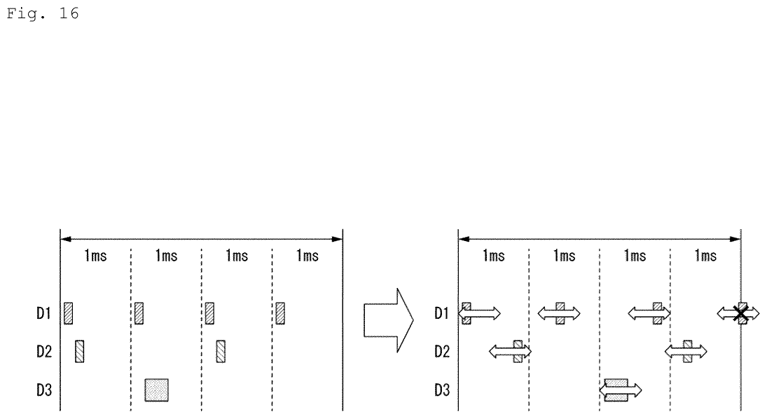

### DESCRIPTION OF EMBODIMENTS

An embodiment of the present invention will be described in detail with reference to the drawings.

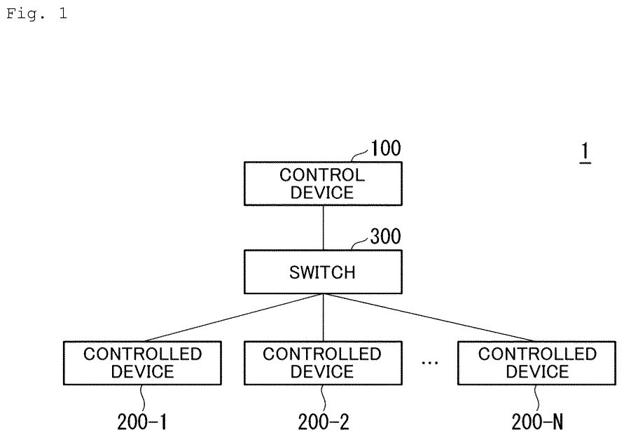

FIG. 1 is a diagram illustrating a configuration example of a communication system 1 including a control device 100 according to an embodiment. The communication system 1 includes the control device 100, a switch 300, and N controlled devices 200-1, 200-2, and 200-N. The controlled devices 200-1, 200-2, and 200-N are referred to as a controlled device 200 when they are not particularly distinguished from each other.

The control device 100 receives transmission information transmitted from each controlled device 200. The control device 100 derives control information for each controlled device 200 based on the transmission information received from each controlled device 200, and transmits the derived control information to the controlled device 200 that is the transmission source. The switch 300 is a network switch. The controlled device 200 is an Internet-of-Things (IoT) device (for example, industrial devices such as sensors, motors, inverters and robots). Therefore, the transmission information transmitted by the controlled device 200 is information indicating, for example, sensor readings.

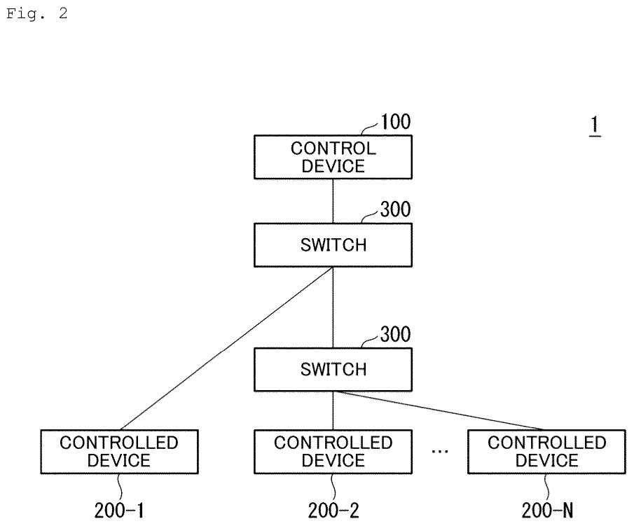

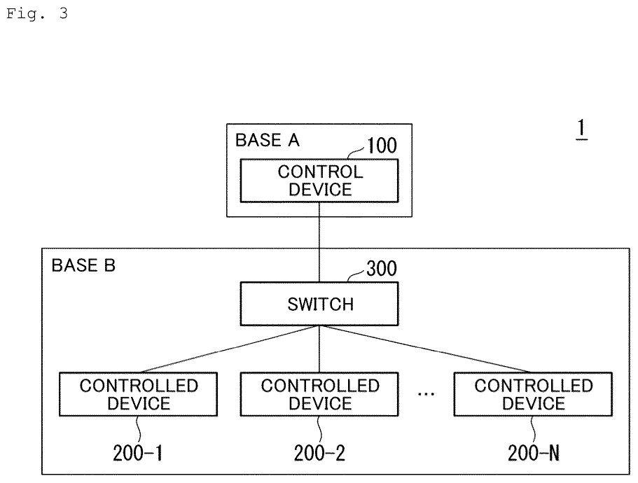

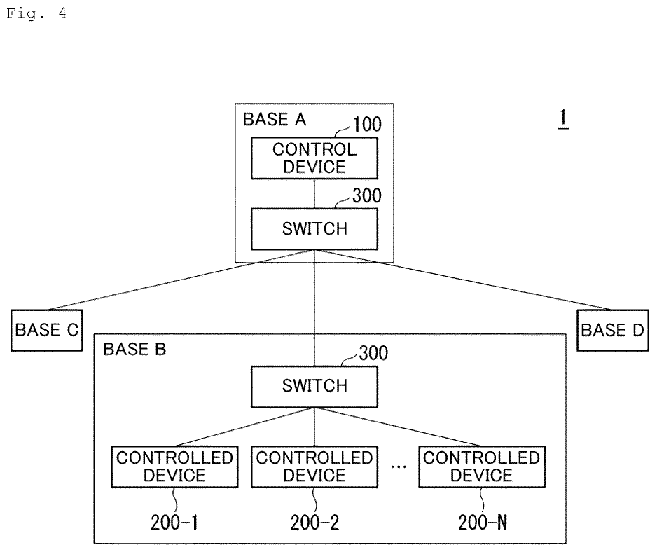

A connection between the control device 100 and the controlled device 200 is not limited to the connection illustrated in FIG. 1. Other examples will be described with reference to FIGS. 2 to 4. FIG. 2 is a diagram illustrating a connection in which the control device 100 and the controlled device 200 are connected by one or more switches 300. FIG. 3 is a diagram illustrating a connection in when the control device 100 and the controlled device 200 belong to different bases respectively. A base A and a base B may be connected by Ethernet or optical fibers. Further in FIG. 3, they may be connected by a plurality of switches 300. FIG. 4 is a diagram illustrating a connection in which the control device 100 and the controlled device 200 belong to different bases and there are a plurality of bases.

An embodiment applicable to each connection example stated above will be described hereinbelow.

### First Embodiment

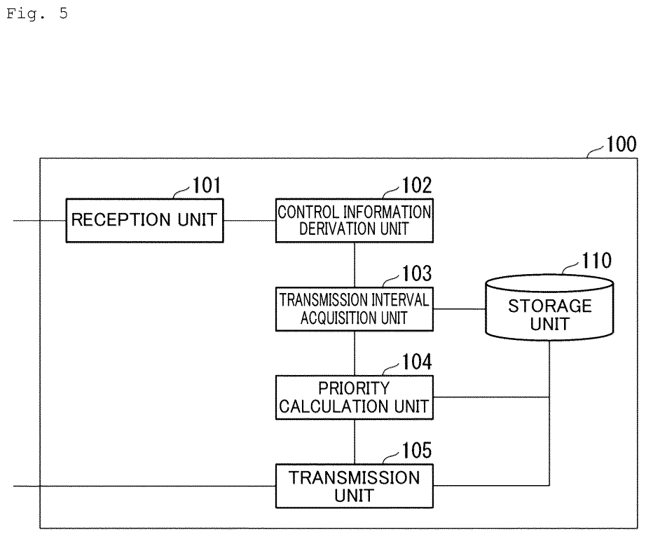

FIG. 5 is a diagram illustrating a configuration example of the control device 100 according to a first embodiment. The control device 100 includes a reception unit 101, a control information derivation unit 102, a transmission interval acquisition unit 103, a priority calculation unit 104, a transmission unit 105 and a storage unit 110.

The reception unit 101 receives transmission information transmitted from a plurality of controlled devices 200. The received transmission information is output to the control information derivation unit 102. The control information derivation unit 102 derives control information for controlling the controlled device 200 that has transmitted the transmission information according to the transmission information received by the reception unit 101. The transmission interval acquisition unit 103 acquires a transmission interval predetermined for each piece of control information from the storage unit 110 as an interval for transmitting the control information derived by the control information derivation unit 102. Since the transmission interval herein is an interval at which the control information is transmitted, it can also be referred to an interval at which the control information is updated.

The priority calculation unit 104 calculates a priority indicating that control information with a shorter transmission interval acquired by the transmission interval acquisition unit 103 should be transmitted preferentially, as a priority of transmitting control information. For example, there are six levels of priority from 1 to 6. The higher the level is, the higher the priority is; and the higher the priority is, the higher the priority for transmission is. The calculated priority is stored in storage unit 110. The transmission unit 105 refers to the storage unit 110 and transmits the control information according to the priority calculated by the priority calculation unit 104.

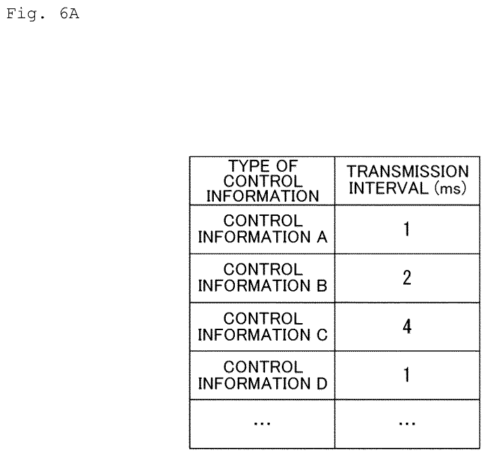

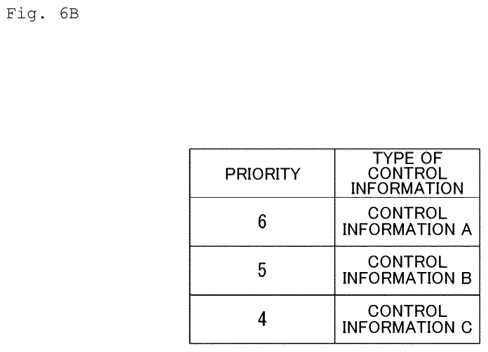

FIG. 6A shows a transmission interval database indicating transmission intervals of control information. The transmission interval database is a database that stores transmission intervals corresponding to types of control information. The type of control information corresponds to, for example, the type of controlled device, and is used to distinguish control information. The transmission interval acquisition unit 103 acquires a transmission interval corresponding to the type of control information derived by the control information derivation unit 102. FIG. 6A shows control information A to D with transmission intervals of 1 ms, 2 ms, 4 ms, and 1 ms, respectively.

FIG. 6B shows a priority database illustrating priorities of control information. The priority calculation unit 104 calculates a priority indicating that control information with a shorter transmission interval acquired by the transmission interval acquisition unit 103 should be transmitted preferentially. FIG. 6B shows a priority when the pieces of control information A, B, and C are transmitted in the control device 100 among several pieces of control information as one example. Transmission intervals of control information A, B, and Care 1 ms, 2 ms, and 4 ms, respectively. Therefore, the control information A has the highest priority, the control information B has the second highest priority, and the control information C has the lowest priority. Accordingly, the priority calculation unit 104 calculates the priority of the control information A as 6, the priority of the control information B as 5, and the priority of the control information A as 4. Such calculated priorities are stored in the storage unit 110 as a priority database as illustrated in FIG. 6B.

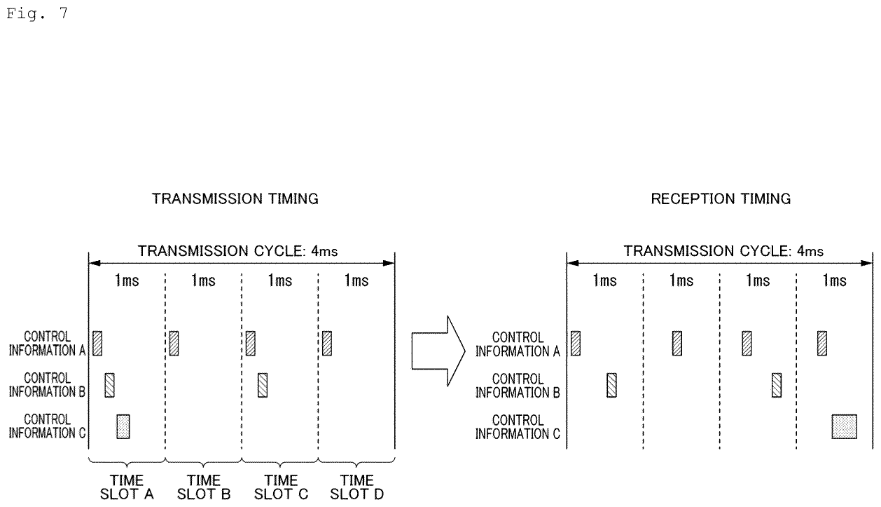

FIG. 7 is a diagram illustrating a transmission timing of the control information in the control device 100 and a reception timing of the control information in the controlled device 200. FIG. 7 shows an example of transmission/reception for the priority illustrated in FIG. 6B.

As shown in FIG. 7, the transmission unit 105 sets the longest interval (4 ms of the control information C) among the transmission intervals acquired by the transmission interval acquisition unit 103 as a transmission cycle, and transmits the control information in descending order of priority (in the order of control information A, B, and C) each time the transmission cycle starts. For example, the control information A, B, and C are transmitted in this order in a time slot A. Furthermore, the control information A and B are transmitted in this order in a time slot C. By transmitting the control information in descending order of priority, it is possible to receive the control information with higher priority earlier, and even if a delay occurs, there is a larger time margin than in prior arts, thus it becomes possible to ensure real-time performance in a more reliable manner.

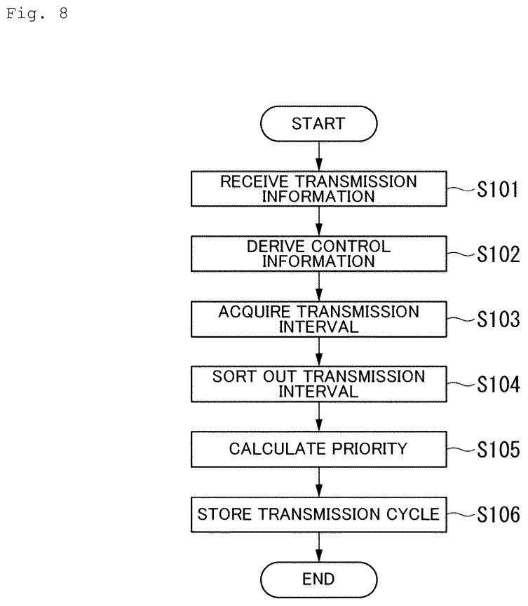

A flow of processing of the control device according to the first embodiment will be described with a flowchart. FIG. 8 is a flowchart showing a flow of processing when the control device receives the transmission information according to the first embodiment. In FIG. 8, the reception unit 101 receives the transmission information (step S101). The control information derivation unit 102 derives the control information for controlling the controlled device 200 that has transmitted the transmission information according to the received transmission information (step S102). The transmission interval acquisition unit 103 acquires a transmission interval determined for each piece of control information as an interval for transmitting the control information derived by the control information derivation unit 102 (step S103).

The priority calculation unit 104 sorts out the transmission intervals acquired by the transmission interval acquisition unit 103 for the priority for transmitting control information (step S104), and calculates a priority indicating that control information with a shorter transmission interval should be transmitted preferentially (step S105). The transmission unit 105 stores the longest interval among the transmission intervals acquired by the transmission interval acquisition unit 103 in the storage unit 110 as the transmission cycle (step S106).

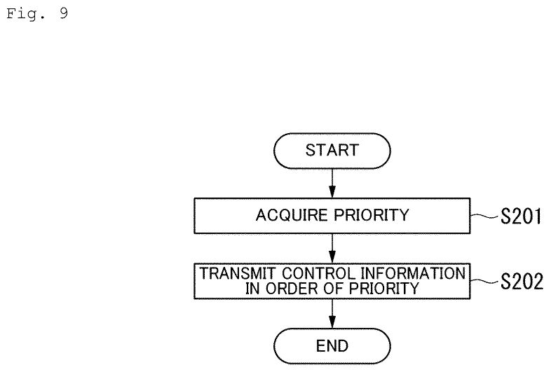

FIG. 9 is a flowchart illustrating a flow of processing when a transfer cycle starts according to the first embodiment. When the transfer cycle starts, the transmission unit 105 acquires a priority (step S201). As illustrated in FIG. 7, the transmission unit 105 transmits the control information in descending order of priority.

As described above, by calculating the priority according to the transmission interval, the transmission information for which delay is not allowed is transmitted preferentially; therefore, it is possible to ensure real-time performance in a more reliable manner as compared to a case where the uniformed priority is assigned to all devices as in prior art.

### Second Embodiment

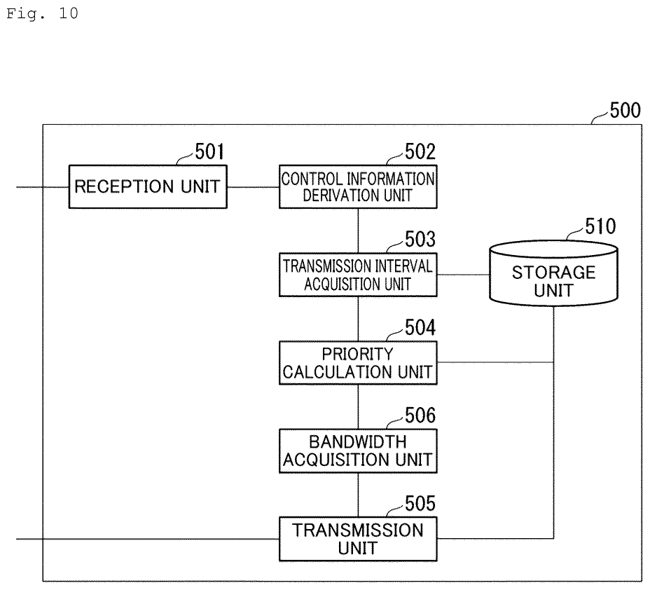

A second embodiment is an embodiment in which the control device changes the transmission order according to a bandwidth of the network through which the control information is transmitted. FIG. 10 is a diagram illustrating a configuration example of the control device 500 according to the second embodiment. The control device 500 includes a reception unit 501, a control information derivation unit 502, a transmission interval acquisition unit 503, a priority calculation unit 504, a transmission unit 505, a bandwidth acquisition unit 506 and a storage unit 110.

The reception unit 501 receives transmission information transmitted from a plurality of controlled devices 200. The received transmission information is output to the control information derivation unit 502. The control information derivation unit 502 derives control information for controlling the controlled device 200 that has transmitted the transmission information according to the transmission information received by the reception unit 501. The transmission interval acquisition unit 503 acquires a transmission interval predetermined for each piece of control information from the storage unit 510 as an interval for transmitting the control information derived by the control information derivation unit 502. Since the transmission interval herein is an interval at which the control information is transmitted, it can also be referred to an interval at which the control information is updated.

The priority calculation unit 504 calculates a priority indicating that control information with a shorter transmission interval acquired by the transmission interval acquisition unit 503 should be transmitted preferentially, as a priority of transmitting control information. For example, there are six levels of priority from 1 to 6, and the higher the priority is, the higher the priority of transmission is.

The calculated priority is stored in storage unit 510. The transmission unit 505 refers to the storage unit 510 and transmits the control information according to the priority calculated by the priority calculation unit 504.

The bandwidth acquisition unit 506 acquires a bandwidth (bps) of the network that transmits the control information. For example, an acquisition method adopted by the bandwidth acquisition unit 506 is as follows. First, a method of sniffing packets flowing through the network may be used. Alternatively, it is possible to employ a method of acquiring a bandwidth from a communication device such as an optical line terminal (OLT). Furthermore, if the control device 500 has a subordinate communication device, it is also possible to adopt a method of acquiring a bandwidth from this communication device in the form of a gate report. The acquisition method is not limited to these methods. The acquired bandwidth is output to the transmission unit 505. An increase in the number of controlled devices 200 is one of reasons by which the bandwidth becomes narrower.

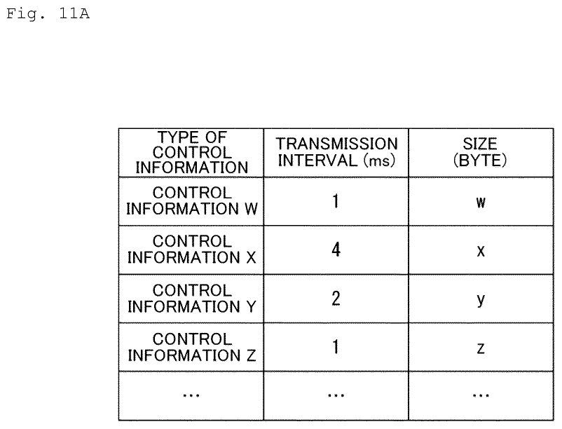

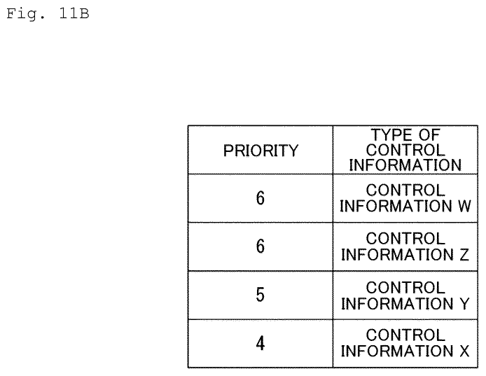

FIG. 11A shows a transmission interval size database indicating transmission intervals and sizes of control information. The transmission interval size database is a database that stores transmission intervals and sizes corresponding to types of control information. The type of control information corresponds to, for example, the type of controlled device, and is used to distinguish control information. The transmission interval acquisition unit 503 acquires a transmission interval corresponding to the type of control information derived by the control information derivation unit 502. FIG. 11A shows control information W to Z with transmission intervals of 1 ms, 4 ms, 2 ms, and 1 ms, respectively. Further, the sizes of pieces of control information W to Z are w bytes, x bytes, y bytes, and z bytes, respectively.

FIG. 11B shows a priority database illustrating priorities of control information. The priority calculation unit 504 calculates a priority indicating that control information with a shorter transmission interval acquired by the transmission interval acquisition unit 503 should be transmitted preferentially. FIG. 11B shows a priority when the pieces of control information W, X, Y and Z are transmitted in the control device 500 among several pieces of control information as one example. The pieces of control information W to Z have transmission intervals of 1 ms, 4 ms, 2 ms, and 1 ms, respectively.

Therefore, the pieces of control information W and Z have the highest priority, the control information Y has the second highest priority, and the control information X has the lowest priority. Accordingly, the priority calculation unit 104 calculates the priority of the control information W and Z as 6, the priority of the control information Y as 5, and the priority of the control information X as 4. Such calculated priorities are stored in the storage unit 110 as a priority database as illustrated in FIG. 11B.

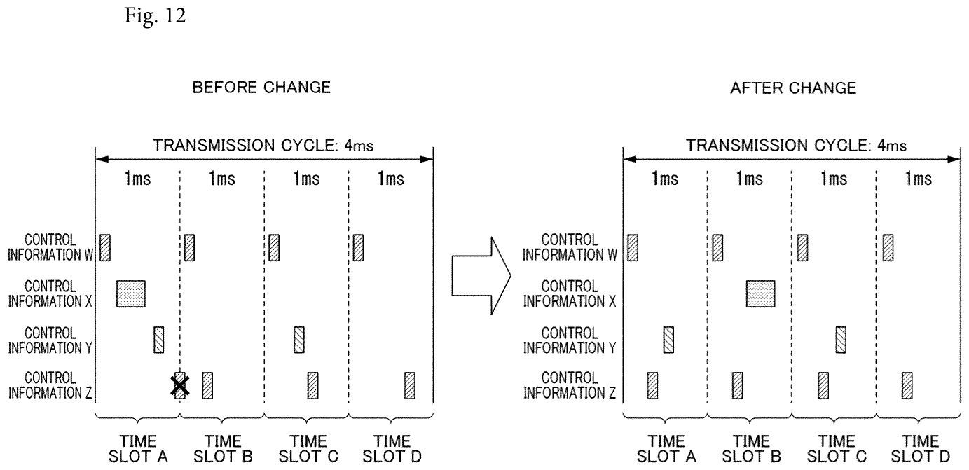

FIG. 12 is a diagram illustrating an example of changing the transmission order. FIG. 12 is a diagram illustrating transmission timings of the control information in the control device 500 before and after the change. FIG. 12 shows a transmission example for the priority shown in FIG. 11B.

As illustrated in FIG. 12, if the pieces of control information W, X, Y, and Z are transmitted in the order of a time slot A before the change, its bandwidth exceeds a transmittable bandwidth, and the control information Z cannot be transmitted in time. Therefore, the transmission unit 505 transmits the control information X, which has a lower priority than that of the control information Z, in any of subsequent time slots. As shown with the changed timing, the control information X is transmitted in the next time slot B. Accordingly, the control device 500 can transmit the control information Z in time.

When a bandwidth for transmitting one piece of control information (control information Z in FIG. 12) to be transmitted in a certain time slot exceeds the bandwidth obtained by the bandwidth acquisition unit 506, so that the one piece of control information cannot be transmitted, the transmission unit 505 transmits the control information (control information X in FIG. 12) with a transmission interval longer than the transmission interval of the one piece of control information in any of subsequent time slots, thereby transmitting the one piece of control information. Further, the transmission unit 505 sets the control information with a transmission interval longer than the transmission interval of the one piece of control information as control information with a lower priority than the priority of the one piece of control information.

In the example shown in FIG. 12, the control information with the lowest priority was transmitted in any of subsequent time slots, but it does not necessarily have to be the control information with the lowest priority. For example, if the control information Y can be transmitted in any of subsequent time slots, the control information Y may be transmitted in any of subsequent time slots instead of the control information X.

By transmitting the control information with the lower priority in any of subsequent time slots in this way, it is possible to transmit the control information with the higher priority even if the bandwidth becomes narrow, so that real-time performance can be ensured in a more reliable manner.

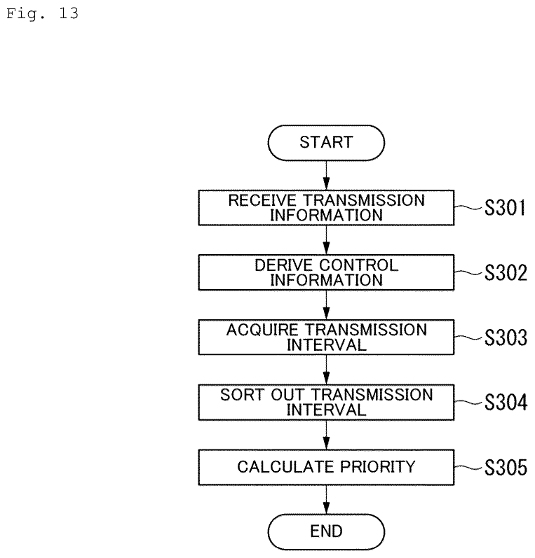

A flow of processing of the control device according to the second embodiment will be described with a flowchart. FIG. 13 is a flowchart showing a flow of processing when the control device receives the transmission information according to the second embodiment. In FIG. 13, the reception unit 501 receives the transmission information (step S301). The control information derivation unit 502 derives the control information for controlling the controlled device 200 that has transmitted the transmission information according to the received transmission information (step S302). The transmission interval acquisition unit 503 acquires a transmission interval determined for each piece of control information as an interval for transmitting the control information derived by the control information derivation unit 502 (step S303).

The priority calculation unit 504 sorts out the transmission intervals acquired by the transmission interval acquisition unit 503 for the priority for transmitting control information (step S304), and calculates a priority indicating that control information with a shorter transmission interval should be transmitted preferentially (step S305).

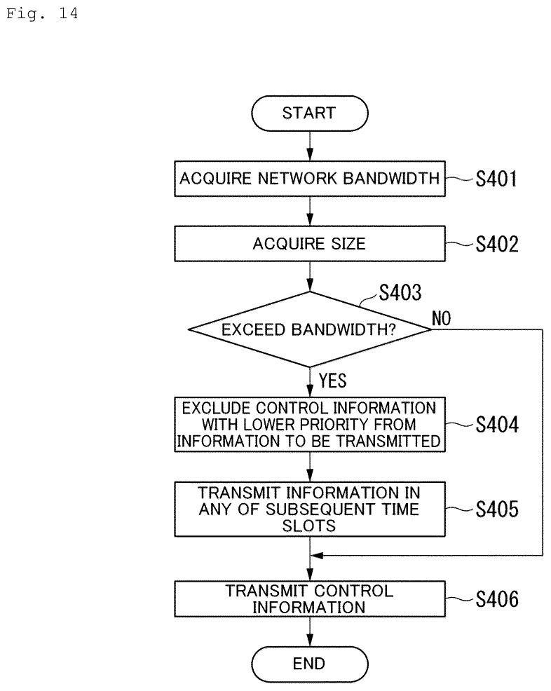

FIG. 14 is a flowchart showing a flow of processing when transmitting the control information according to the second embodiment. In FIG. 14, the bandwidth acquisition unit 506 acquires a bandwidth of the network that transmits control information (step S401). The transmission unit 505 acquires a size (step S402). The size refers to the total size of pieces of control information to be transmitted. With the time slot A before the change in FIG. 12 as an example, the “size” means the sum (w+x+y+z) of the sizes of the pieces of control information W, X, Y, and Z.

The transmission unit 505 determines whether or not the size exceeds the bandwidth (step S403). Taking the time slot A before the change in FIG. 12 as an example and denoting the bandwidth acquired by the bandwidth acquisition unit 506 as P(bps), the transmission unit 505 determines whether the sum of bytes converted into bits, i.e. 8×(w+x+y+z), exceeds P.

If the size does not exceed the bandwidth (step S403: NO), the transmission unit 505 transmits the control information as is (step S406). On the other hand, if the size does not exceed the bandwidth (step S403: NO), the transmission unit 505 excludes the control information with a lower priority, among pieces of control information to be transmitted, from the control information to be transmitted this time (step S404).

The transmission unit 505 determines to transmit the excluded control information in any of subsequent time slots (step S405). The transmission unit 505 transmits control information other than the excluded control information (step S406).

The number of pieces of control information to be excluded in step 8404 is not limited to one, and the control information with a lower priority is excluded until the control information to be transmitted in the current time slot can be transmitted. When no control information that can be excluded remains, the transmission unit 505 transmits the control information in descending order of priority.

As explained above, by transmitting the control information with a lower priority in any of subsequent time slots, it is possible to transmit the control information with a higher priority even if the bandwidth becomes narrower, so real-time performance can be ensured in a more reliable manner.

The control devices 100 and 500 may be configured using a processor such as a central processing unit (CPU) and a memory. In this case, the reception units 101 and 501, the control information derivation units 102 and 502, the transmission interval acquisition units 103 and 503, the priority calculation units 104 and 504, the transmission units 105 and 505, and the bandwidth acquisition unit 506 function as the reception units 101 and 501, the control information derivation units 102 and 502, the transmission interval acquisition units 103 and 503, the priority calculation units 104 and 504, the transmission units 105 and 505, and the bandwidth acquisition unit 506, respectively, by means of the processor executing a program. All or some of the functions in the reception units 101 and 501, the control information derivation units 102 and 502, the transmission interval acquisition units 103 and 503, the priority calculation units 104 and 504, the transmission units 105 and 505, and the bandwidth acquisition unit 506 may be implemented using hardware such as an application specific integrated circuit (ASIC), a programmable logic device (PLD), or a field programmable gate array (FPGA). The aforementioned program may be recorded in a computer-readable recording medium. The computer-readable recording medium is, for example, a portable medium such as a flexible disk, a magneto-optical disk, a ROM, a CD-ROM, or a semiconductor storage device (a solid state drive (SSD), for example), or a storage device such as a hard disk and a semiconductor storage device incorporated in a computer system. The above program may be transmitted via a telecommunication line.

Although the embodiment of the present invention has been described in detail with reference to the drawings, a specific configuration is not limited to this embodiment, and modifications may be encompassed in the present invention as long as they do not depart from the scope of the present invention.

### INDUSTRIAL APPLICABILITY

The present invention is applicable to a control device that establish communication with a controlled device while ensuring real-time performance.

### REFERENCE SIGNS LIST

1: Communication system
100, 500: Control device
101: Reception unit
102: Control information derivation unit
103: Transmission interval acquisition unit
104: Priority calculation unit
105: Transmission unit
110: Storage unit
200, 200-1, 200-2, 200-N: Controlled device
300: Switch
501: Reception unit
502: Control information derivation unit
503: Transmission interval acquisition unit
504: Priority calculation unit
505: Transmission unit
506: Bandwidth acquisition unit
510: Storage unit

1. A control device comprising:
a processor; and
a storage medium having computer program instructions stored thereon, when executed by the processor, perform to:
receive transmission information transmitted from a plurality of controlled devices;
derive control information for controlling the controlled device that has transmitted the transmission information according to the transmission information received;
acquire a transmission interval determined for each piece of control information as an interval for transmitting the control information;
calculate a priority indicating that the control information with a shorter transmission interval is to be transmitted preferentially, as a priority for transmitting the control information; and
transmit the control information according to the priority.

2. The control device according to claim 1, wherein the computer program instructions further perform to set the longest interval among the transmission intervals as a transmission cycle, and transmit the control information in descending order of the priority per each transmission cycle.

3. (canceled)

4. (canceled)

5. A control method comprising:
a reception step of receiving transmission information transmitted from a plurality of controlled devices;
a control information derivation step of deriving control information for controlling the controlled device that has transmitted the transmission information according to the transmission information received in the reception step;
a transmission interval acquisition step of acquiring a transmission interval determined for each piece of control information as an interval for transmitting the control information derived in the control information derivation step;
a priority calculation step of calculating a priority indicating that the control information with a shorter transmission interval acquired in the transmission interval acquisition step is to be transmitted preferentially, as a priority for transmitting the control information; and
a transmission step of transmitting the control information according to the priority calculated in the priority calculation step.

6. (canceled)

7. A non-transitory computer-readable medium having computer-executable instructions that, upon execution of the instructions by a processor of a computer, cause the computer to:
receive transmission information transmitted from a plurality of controlled devices;
derive control information for controlling the controlled device that has transmitted the transmission information according to the transmission information;
acquire a transmission interval determined for each piece of control information as an interval for transmitting the control information;
calculate a priority indicating that the control information with a shorter transmission interval is to be transmitted preferentially, as a priority for transmitting the control information; and
transmission transmit the control information according to the priority.

8. (canceled)
